(19) United States
(12) Patent Application Publication
(10) Pub. No.: US 2014/0360624 A1
(43) Pub. Date: Dec. 11, 2014

(54) FILLER ELEMENT AND FILLING SYSTEM

(71) Applicant: KHS GmbH, Dortmund (DE)

(72) Inventors: Ludwig Clusserath, Bad Kreuznach (DE); Dieter-Rudolf Krulitsch, Bad Kreuznach (DE)

(73) Assignee: HKS GmbH, Dortmund (DE)

(21) Appl. No.: 14/363,021

(22) PCT Filed: Nov. 23, 2012
(86) PCT No.: PCT/EP2012/004867

§ 371 Date: Jun. 5, 2014

(30) Foreign Application Priority Data
Dec. 6, 2011 (DE) 10 2011 120 164.9

(51) Int. Cl. B67C 3/00; B67C 3/26

(52) U.S. Cl. CPC B67C 3/001; B67C 3/2637; B67C 2003/2685
USPC 141/91; 141/95

(57) ABSTRACT

A filler element for filling containers with liquid includes a housing, a housing opening area, a protective space, a channel formed therein, a liquid valve in the channel, a dispensing opening downstream from the valve, and a fill-level-determining element comprising first and second ends. The fill-level-determining element is routed through the housing and extends by the first end into the dispensing opening during filling and is routed out of the housing by the second end at a housing opening area in a sealed manner with a protective space directly adjacent to it. The protective space holds a length of the fill-level-determining element that corresponds to an axial adjustment lift. The protective space opens by an axial opening lift of the fill-level-determining element that differs from its axial adjustment lift. The protective space opens by the axial opening lift of the fill-level-determining element into a space formed in the housing.

### RELATED APPLICATIONS

This application is the national stage entry, under 35 USC 371, of PCT application PCT/EP2012/004867, filed on Nov. 23, 2012, which claims the benefit of the Dec. 6, 2011 priority date of DE 10 2011 120 164.9, the contents of which are herein incorporated by reference.

### FIELD OF INVENTION

The invention is directed to container processing, and in particular, to filling containers with liquid.

### BACKGROUND

Various kinds of filler elements for filling containers, including bottles, with liquid contents, for example drinks, are known. It is also known to provide, on a filler element, an element that determines the fill level of the contents in the filled container. This element, which is hereinafter called the “fill level-determining element”), can be in the form of a rod-shaped probe with at least one electric probe contact, or in the form of a gas-return pipe. It is also known to set the fill level reached in a particular container at the end of the filling process by axial adjustment of the fill level-determining element during filling with a first end extending into the container. The fill level-determining element is furthermore routed through the filler-element housing of the filler element and projects out of the filler-element housing by a length lying at a distance from the first end on a housing opening area.

To prevent the penetration of dirt and/or microorganisms into the process side of the filler element by means of the housing opening area, i.e. into areas of the filler element transporting the contents and/or process gas and/or vacuum, in particular when adjusting the fill level-determining element, it is known to provide a protective space in the filler element immediately after the opening area.

During the filling operation, this protective area is exposed, for example, to the pressure of an inert gas, separated from areas transporting process gas and/or contents by at least one seal and made such that it can accommodate, at least in the filling mode of the filler element, a length of the fill level-determining element on the housing side adjacent to the housing opening area, the length corresponding to the adjustment range of this element.

A disadvantage in this known filler element is that this protective space is formed by the internal space of a pipe that projects out of the filler-element housing above the dispensing opening, and that, on the lower end of this pipe enclosing the fill level-determining element, the sealing element separating the protective space from the process side is provided in the form of a solid ring seal. In the filling mode, the fill level-determining element is routed through the ring seal while the protective space is sealed. In a cleaning and/or sterilization mode, the fill level-determining element is moved back by its first end so far into the filling element housing that the protective space on the ring seal is open. Considerable disadvantages arise from this because the annular space enclosing the fill level-determining element is used as the protective space and is therefore not available as the gas space or gas channel for the medium to pass through, i.e. additional fluid paths may have to be provided in the filler element. Additionally, the ring seal separating the protective space from the process side is exposed to the risk of damage, for example the risk of damage from glass splinters from burst containers or bottles. In addition, during a CIP cleaning and/or sterilization in which the protective space and the fill level-determining element are likewise cleaned and/or sterilized, it is not possible to also concurrently clean and/or to sterilize a part of the fill level-determining element extending into the protective space during the filling operation because this will be outside the filler element at the time of the cleaning and/or sterilization.

### SUMMARY

It is the task of the invention to disclose a filler element that avoids the aforesaid disadvantages and, with high operating reliability, in particular also allows an optimal cleaning and/or disinfection and/or sterilization of the fill level-determining element.

In one aspect, the invention features a filler element for filling containers with liquid contents. The filler element comprising a housing, a housing opening area, a protective space, a liquid channel, a liquid valve in the liquid channel, a dispensing opening, and a fill-level-determining element comprising a first end and a second end. The dispensing opening is downstream from the liquid valve in a direction of flow of the liquid contents. The liquid contents pass through the dispensing opening into the container when the liquid valve is open. The fill-level-determining element, which determines a fill level of the liquid contents in the container, is routed through the filler-element housing and extends by the first end into the dispensing opening during filling of the container and is routed out of the housing by the second end, which is at a distance from the first end, at the housing opening area in a sealed manner with a protective space directly adjacent to the housing opening area. The protective space is sized and configured to hold a length of the fill-level-determining element that corresponds to an axial adjustment lift. The protective space is opened by an axial opening lift of the fill-level-determining element. The axial opening lift of the fill-level-determining element is different from the axial adjustment lift of the fill-level-determining element. The protective space opens by the axial opening lift of the fill-level-determining element into a space formed in the filler-element housing.

In some embodiments, the fill-level-determining element comprises one of a gas-return pipe and a rod-shaped probe with at least one probe contact at the first end.

Other embodiments further include a gas pipe enclosing the fill-level-determining element but spaced from the fill-level-determining element. The gas pipe projects out of the filler-element housing and forms a gas channel that encloses the fill-level-determining element. The gas channel opens into the space formed in the filler-element housing. The protective space is provided in the filler-element housing offset relative to the gas pipe and the gas channel to the second end of the fill-level-determining element.

In another embodiment, the fill-level-determining element can be moved in an opening lift to open the protective space, the opening lift being greater than the maximum adjustment lift.

In yet another embodiment, the fill-level-determining element can be moved to open the protective space in a direction of an underside of the filler element having the dispensing opening.

Some embodiments include a sealing element, a housing recess, and a circular cylindrical section of the housing recess. The protective space is formed by the circular cylindrical section. The sealing element is provided on the fill-level-determining element, and separates the protective space from a process side of the filler element, portions of the filler element that transport process gas, portions of the filler element that transport contents, or portions of the filler element that support a vacuum. The sealing element can be moved by the fill-level-determining elements in a piston-like manner in the section of the housing recess.

Yet other embodiments have a further section adjacent to the section that forms the protective space. The further section is in a direction of the opening lift and forms or is connected to the space formed in the filler-element housing.

In some embodiments, the protective space defines a flow path in the filler-element housing. The flow path enables the protective space to be exposed to a pressurized inert gas during filling. When the protective space is open, the flow path enables either supply or removal of a treatment medium for treatment of the fill-level-determining element and either or both the protective space and the housing recess that forms the protective space. The treatment medium is either a cleaning medium or sterilization medium. Treatment includes cleaning and sterilizing.

Another embodiment includes a rotary filling machine comprising a transport element. The filling element, and a identical filling elements, are disposed on the transport element of the rotary filling machine.

Further developments, benefits and application possibilities of the invention arise also from the following description of examples of embodiments and from the figures. In this regard, all characteristics described and/or illustrated individually or in any combination are categorically the subject of the invention, regardless of their inclusion in the claims or reference to them. The content of the claims is also an integral part of the description.

As used herein, “containers” include cans, bottles, tubes, pouches, in each case made of metal, glass and/or plastic, as well as other packaging means that are suitable for filling with liquid or viscous products.

As used herein, the expressions “substantially” and “approximately” mean deviations from exact values in each case by +/−10%, and preferably by +/−5% and/or deviations in the form of changes not significant for functioning.

### BRIEF DESCRIPTION OF THE DRAWINGS

These and other features and advantages of the invention will be apparent from the accompanying detailed description and the accompanying figures in which:

FIGS. 1-3 show various operating statuses of a filler element of a filling system or of a filling machine of a rotary design for the fill-level-controlled filling of containers in the form of bottles with liquid contents, this being in various operating statuses.

FIGS. 4 and 5 show details associated with the filler element shown in FIGS. 1 and 2.

### DETAILED DESCRIPTION

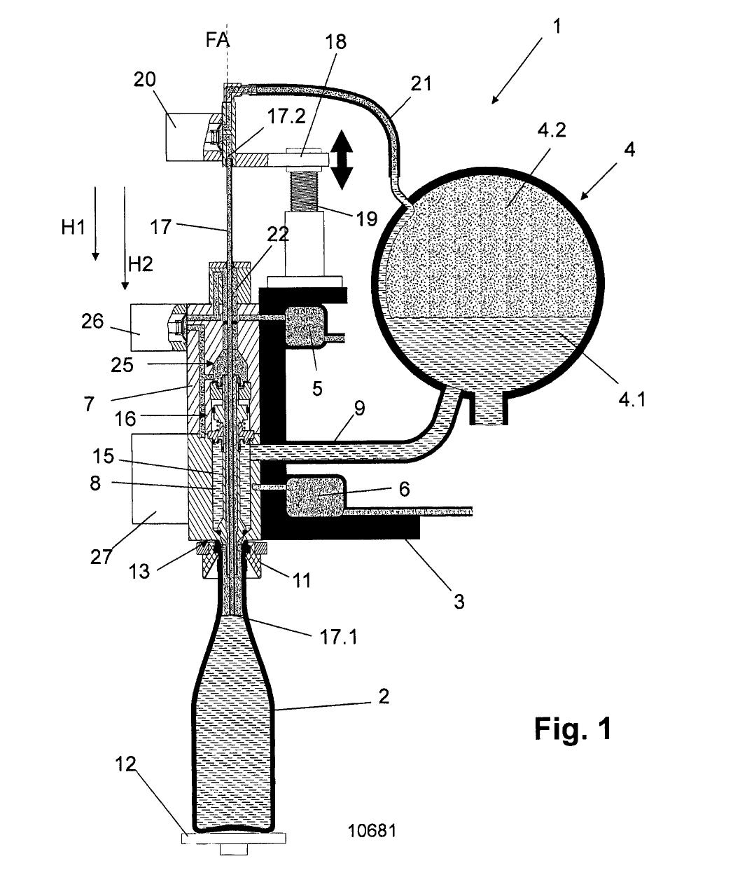

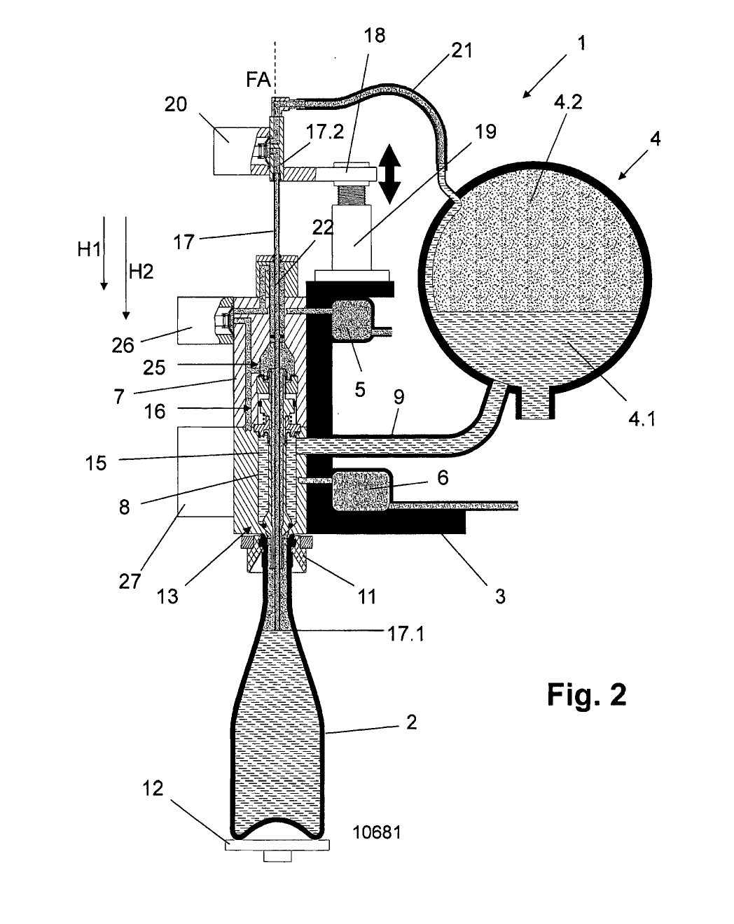

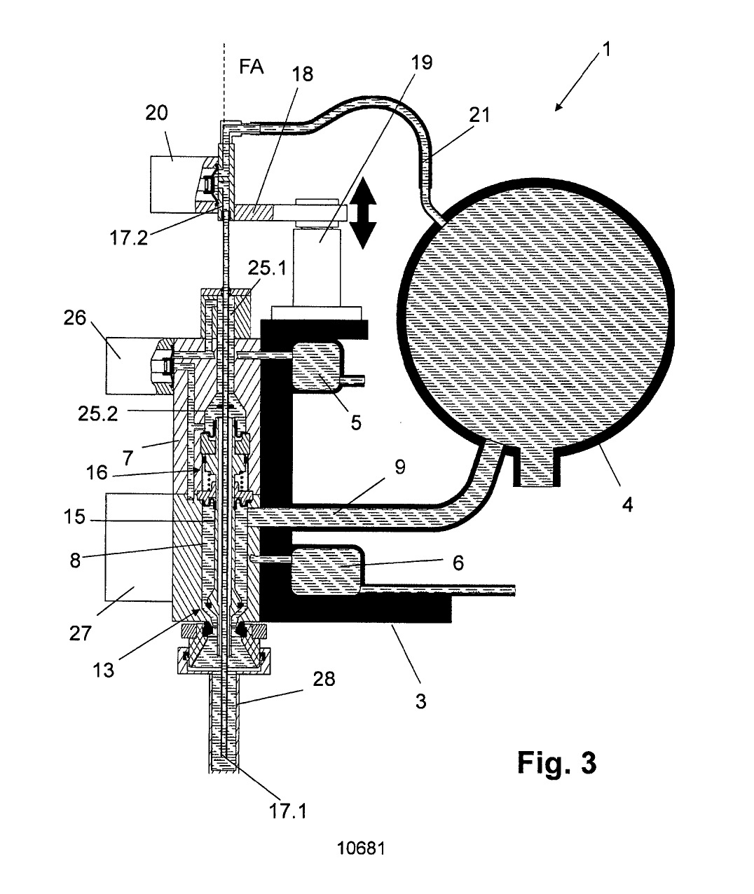

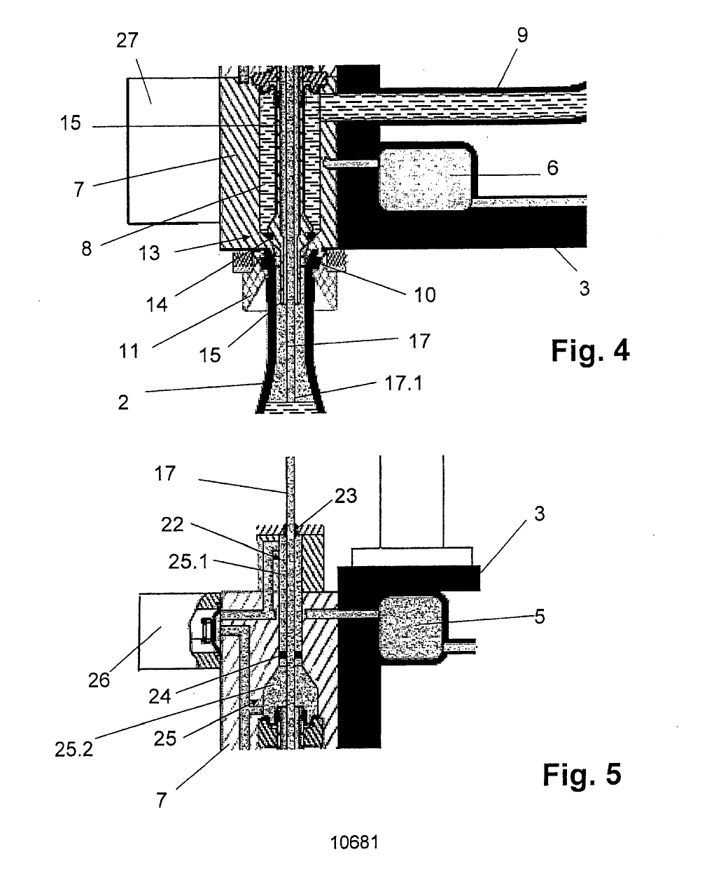

FIG. 1 shows a filler element 1 for the fill-level-controlled filling of containers, such as bottles 2, with liquid contents. The filler element 1, which is illustrated in FIGS. 1 and 2 in a filling mode and in FIG. 3 in a CIP cleaning and/or sterilization mode, is provided together with a plurality of the same kind of filler elements on the circumference of a rotor 3 that can be driven to rotate around a vertical machine axis. The rotor 3 is part of a filling system or a filling machine. On the rotor 3, there is also an annular vat 4 common to all the filler elements 1 of the filling machine for the supply of the liquid contents, and two annular channels 5 and 6.

During the filling operation, the annular channel 4 is partially filled with the liquid contents so that in the annular vat 4, a lower liquid space 4.1 and above it a gas space 4.2 are formed. The gas space 4.2 is filled, for example, with an inert gas (e.g. CO₂ gas) and, especially in the case of a pressure-filling of the bottles 2, with the inert gas under filling pressure.

The annular channels 5 and 6 can have different functions depending on the filling method. The annular channel 5 transports the inert gas under pressure for a rinsing and/or pre-tensioning of the particular bottle provided in a sealed position on the filler element 1 in the case of pressure filling. The annular channel 6 can also function as a pressure-release channel.

The filler element 1 comprises a filler-element housing 7 in which a contents or liquid channel 8 is formed. In its upper area, the channel 8 connects to the liquid space 4.1 of the annular vat 4 by a product pipe 9.

On the underside of housing 7, the liquid channel 8 forms an annular dispensing opening 10 by means of which during the filling, the liquid contents flow to the bottle 2. The bottle 2 has its bottle mouth lying in a sealed position against the filler element 1 by means of a seal of a centering cone 11 in the area of the dispensing opening 10, i.e. in a sealed position with the filler element 1. A container carrier or bottle plate 12 assigned to the filler element 1 raises the bottle into position.

In the liquid channel, in the direction of flow of the contents, a liquid valve 13 with a valve body 14 is provided before the dispensing opening 10, the valve body interacting with a valve surface in the liquid channel 8 and being made on a gas tube 15 arranged on the same axis as a vertical filler element axis FA and acting as a valve plunger, which protrudes through the dispensing opening 10 by means of the underside of the filler element 1 and extends into the bottle 2 concerned during the filling. In FIGS. 1 and 2, which in each case show the end state of the filling process, the liquid valve 13 is shown in the closed state. For the controlled opening and closing of the liquid valve 13, a pneumatic actuation device 16 acting on the gas pipe 16 is provided, which is housed in an inner space of the housing 7, the inner space being separated from the liquid channel 8 and sealed from the liquid channel 8.

The filler element 1 has, furthermore, a gas-return pipe 17 arranged on the same axis at the filler element axis FA, open at both ends and enclosed by the gas pipe 15 but spaced from it, the gas-return pipe as a fill-level-determining element, projecting by its end 17.1 during the filling operation likewise into the upper area or the head-space of the bottle 2 and by means of the lower open end of the gas pipe 15.

The gas-return pipe 17 is routed through the filler-element housing 7, projects with its upper length via the top side of this housing and is held with the likewise open end 17.2 there on a support arm 18 of an adjustment device 19 with which the gas-return pipe can be moved axially in a way that is described below in more detail, in each case from an upper starting or lift position downwards to set different fill levels during the filling mode of the filler element 1 in an adjustment lift H1 and to move the gas-return pipe 17 into a cleaning and/or sterilization position, i.e. to transfer the filler element 1 into the cleaning and/or sterilization mode in an enlarged opening lift H2.

The top end 17.2 of the gas-return pipe is connected to the gas space 4.2 of the annular vat 4 by a control valve 20 likewise provided on the support arm and by a flexible pipe 20.

In order, with the axial adjustment of the gas-return pipe 17, i.e. upon setting the fill level to which the bottles 2 are filled in each case with the liquid contents, to prevent the penetration of dirt and/or microorganisms into critical areas or into the process side of the filler element 1, the gas-return pipe 17 is routed before its emergence on the top side of the housing 7 through a protective or lock space 22 formed in the housing 7, which space in the illustrated embodiment is designed in a circular cylindrical shape concentric to the filler element axis FA and has, relative to the filler element axis FA, an axial length that is at least equal to the maximum adjustment lift H1 around which the gas-return pipe 17 is moved between the “maximum fill level” setting and the “minimum fill level” setting.

On the top side of the housing 7, the gas-return pipe 17 is routed through a solid seal 23 out of the housing 7 or out of the lock space 22. The seal 23 forms the upper housing opening area for the gas-return pipe 17. Moreover, on the gas-return pipe 17, a seal 24 enclosing this pipe and moved with it in a piston-like manner is provided. This seal lies sealed against the gas-return pipe 17 and against the circular cylindrical inner surface of the protective space 22 and closes the protective space 22 on its lower side turned away from the seal 23 during the normal filling operation or with the filler element 1 in the filling mode. In the filling mode, the protective space 22 is exposed preferably to a pressurized inert gas from the annular channel 5. In detail, the protective space 22, the axial length of which changes with the adjustment lift H1, is formed in the illustrated embodiment in an upper circular cylindrical section 25.1 of a housing recess 25. At a section 5.2 adjacent to the section 25.1 in the direction towards the underside of the filler element 1, the housing recess 25 has a widened cross-section. The section 5.2 forms a gas space into which the upper open end of the gas pipe 15 or the annular gas channel formed between the inner surface of the gas pipe 15 and the outer surface of the gas-return pipe 17 opens. The section 25.1 and thus also the protective space 22 have an axial length which is larger than the maximum adjustment lift H1 of the gas-return pipe 17 between the “maximum fill level” setting (FIG. 1) and the “minimum fill level” setting (FIG. 2).

Inside the housing 7 moreover, controlled gas paths with control valves 26 and 27 are provided by means of which the protective space 22 is impacted preferably at least during the normal filling operation constantly with a pressurized inert gas from the annular channel 5 and by means of which the section 25.2 or the corresponding gas space, controlled by means of the control valve 26, can be connected to the annular channel 5 or by means of the control valve 27 to the annular channel 6.

With the filler element 1 or with the filling system formed by these filler elements, various filling methods are possible, for example a “normal” pressure-filling of the bottles 2.

With this filling method, with the liquid valve 13 open, the liquid contents flow to the inside of the bottle 2 held in a sealed position on the filler element 1 and pre-tensioned with the inert gas. At least at the end of the particular filling phase, with the control valve 20 open, the inert gas forced out of the bottle 2 by the contents is fed by means of the gas-return pipe 17, the open control valve 20 and the pipe 21 into the gas space 4.2 of the annular vat. With the liquid valve 13 still open, the inflow of the contents into the bottle 2 is then ended when the lower open end 17.1 of the gas-return pipe 17 is immersed into the contents level of the contents which have entered the bottle 2 and a state of equilibrium has been reached between the level of the contents in the annular vat 4 and the contents column forming in the gas-return pipe 17. The level of the lower end 17.1 thus determines the fill level of the contents in the particular bottle 2. After closing the liquid valve 13 and the control valve 20 and after depressurizing the head-space of the bottle 2 not occupied by the contents, said bottle is removed from the filler element 1 by lowering.

The fill level wanted in each case is set at the start of the filling operation by the axial adjustment of the gas-return pipe 17 (adjustment lift H1), this being for all filler elements 1.

In addition to this “normal” pressure filling, a Trinox filling method is also possible with the filler element 1, in which once again the gas-return pipe 17 or its end 17.1 determine the fill level.

In this Trinox method, there is intentionally an over-filling of the in each case pre-tensioned bottle 2 arranged in a sealed position on the filler element 1, i.e. a filling above the desired fill level, this being with the liquid valve 13 open and the control valve 20 closed, wherein the inert gas forced out of the inside of the bottle 2 during the filling by the inflowing contents, e.g. by means of the gas channel formed between the gas pipe 15 and the gas-return pipe 17, into the section 25.2 and from there forced into the annular channel 5 by means of the open control valve 26. After closing the liquid valve 13, the head-space of the bottle 2 not occupied by the contents is exposed to pressure, for example by means of the still open control valve 26. By opening the control valve 20, contents are returned by means of the gas-return pipe 17, the open control valve 20 and the pipe 21 out of the overfilled bottle 2 into the annular vat 4 until the lower end 17.1 of the gas-return pipe 17 is outside the contents in the bottle 2. After closing the control valve 20 and after depressurizing the head-space of the filled bottle 2, for example by means of the open control valve 27, the bottle 2 is removed from the filler element. With this Trinox filling method too, the fill level wanted in each case is set by the axial adjustment of the gas-return pipe 17 (adjustment lift H1), this being for all the filler elements 1 of the filling machine.

To clean and/or to sterilize the housing recess 25 and thus in any case also the section 25.1 of this housing recess, forming the protective space 22, and the gas-return pipe 17 at least over its length held in the filler element 1 during the filling operation, the gas-return pipe 17 is moved from its upper lift position in the opening lift H2 axially downwards until the seal 24 is in the section 25.2 and the protective space 22 is opened to the section 25.2.

The cleaning and/or sterilization of the housing recess 25 and the gas-return pipe 17 take place in the context of a CIP cleaning and/or sterilization of the filling machine, on the filler elements 1 of which in each case one rinsing cap 28 is arranged. In the inside of the rinsing cap 28 closed to the outside, when the liquid valve is open, not only the annular dispensing opening 10 enclosing the gas pipe 15 opens, but also the lower open end of the gas pipe 15 and the lower open end 17.1 of the gas-return pipe 17. During the CIP cleaning and/or sterilization, the gas-return pipe 17 is held in a space through which the cleaning and/or sterilization medium flows, said space being formed by the housing recess 25 and the gas pipe 15 as well as by the rinsing cap 28, this being by means of a continuous length which in any event is greater than the length by which the gas-return pipe 17 extends, during the filling operation, through the filler-element housing 7 and projects by means of the underside of this housing so that during the CIP cleaning and/or sterilization, an optimal cleaning and/or disinfection of the gas-return pipe 17 is guaranteed in all critical areas.

Other advantages and particularities of the filler element 1 are that the protective space 22 for the adjustment of the gas-return pipe 17 is arranged above the annular gap formed between the gas pipe 15 and the gas-return pipe 17, that this annular gap can be used as a gas path or gas channel for routing the process gas during the normal filling operation, and that in particular also the seal 24 which during the filling operation separates the protective space 22 from the process side, i.e. in the illustrated embodiment from the gas space formed by section 25.2, is housed in a protected manner in the interior of the filler element 1 and therefore can also not be damaged for example by shards of burst bottles 2.

The invention was described above using an example of an embodiment. It is clear that numerous modifications and variations are possible without thereby departing from the inventive idea underlying the invention. Thus, above it is assumed that the gas-return pipe 17 is used as a fill-level-determining element. The advantages of the invention consist however also of a filler element 1 in which the gas-return pipe 17 is replaced by a rod-shaped probe with an electric probe contact.

Having described the invention, and a preferred embodiment thereof, what we claim as new and secured by letters patent is:

1-9. (canceled)

10. An apparatus comprising a filler element for filling containers with liquid contents, said filler element comprising a housing, a housing opening area, a protective space, a liquid channel, a liquid valve, a dispensing opening, and a fill-level-determining element comprising a first end and a second end, wherein said liquid channel is formed in said filler element housing, wherein said liquid contents flow through said liquid channel, wherein said liquid valve is in said liquid channel, wherein said dispensing opening is downstream from said liquid valve in a direction of flow of said liquid contents, wherein said liquid contents pass through said dispensing opening into said container when said liquid valve is open, wherein said fill-level-determining element determines a fill level of said liquid contents in said container, wherein said fill-level-determining element is routed through said filler element housing, wherein said fill-level-determining element extends by said first end into said dispensing opening during filling of said container and is routed out of said housing by said second end, which is at a distance from said first end, at said housing opening area in a sealed manner with a protective space directly adjacent to said housing opening area, said protective space being sized and configured to hold a length of said fill-level-determining element, wherein said length corresponds to an axial adjustment lift, wherein said protective space is opened by an axial opening lift of said fill-level-determining element, wherein said axial opening lift of said fill-level-determining element is different from said axial adjustment lift of said fill-level-determining element, and wherein said protective space opens by said axial opening lift of said fill-level-determining element into a space formed in said filler element housing.

11. The apparatus of claim 10, wherein said fill-level-determining element comprises one of a gas-return pipe and a rod-shaped probe with at least one probe contact at said first end.

12. The apparatus of claim 10, further comprising a gas pipe enclosing said fill level-determining element and spaced from said fill-level-determining element, wherein said gas pipe projects out of said filler element housing, wherein said gas pipe forms a gas channel that encloses said fill level-determining element, wherein said gas channel opens into said space formed in said filler element housing, and wherein said protective space is provided in said filler element housing offset relative to said gas pipe and said gas channel to said second end of said fill level-determining element.

13. The apparatus of claim 10, wherein said fill level-determining element can be moved in an opening lift to open said protective space, said opening lift being greater than said maximum adjustment lift.

14. The apparatus of claim 10, wherein said fill level-determining element can be moved to open said protective space in a direction of an underside of said filler element having said dispensing opening.

15. The apparatus of claim 10, further comprising a sealing element, a housing recess, and a circular cylindrical section of said housing recess, wherein said protective space is formed by said circular cylindrical section, wherein said sealing element is provided on said fill-level-determining element, wherein said sealing element separates said protective space from a structure selected from the group consisting of a process side of said filler element, portions of said filler element that transport process gas, portions of said filler element that transport contents, and portions of said filler element that support a vacuum, wherein said sealing element can be moved by said fill level-determining elements in a piston-like manner in said section of said housing recess.

16. The apparatus of claim 10, further comprising a further section adjacent to said section that forms said protective space, said further section being in a direction of said opening lift and forming or being connected to said space formed in said filler element housing.

17. The apparatus of claim 10, wherein said protective space defines a flow path in said filler element housing, wherein said flow path enables said protective space to be exposed to a pressurized inert gas during filling, wherein, when said protective space is open, said flow path enables at least one of supply and removal of a treatment medium for treatment of said fill-level-determining element and at least one of said protective space and said housing recess that forms said protective space, wherein said treatment medium comprises at least one of cleaning medium and sterilization medium, and wherein treatment comprises one of cleaning and sterilizing.

18. The apparatus of claim 10, further comprising a rotary filling machine comprising a transport element, wherein said filling element, and a plurality of identical filling elements, are disposed on said transport element of said rotary filling machine.
